(19) United States
(12) Patent Application Publication
(10) Pub. No.: US 2025/0381520 A1
(43) Pub. Date: Dec. 18, 2025

(54) ABATEMENT APPARATUS AND METHOD

(71) Applicant: Edwards Limited, Burgess Hill, Sussex (GB)

(72) Inventors: James Hann, Clevedon Somerset (GB); Andrew James Seeley, Clevedon Somerset (GB); George Robert Whittell, Clevedon Somerset (GB)

(21) Appl. No.: 18/838,861

(22) PCT Filed: Feb. 16, 2023
(86) PCT No.: PCT/GB2023/050358

§ 371 Date: Aug. 15, 2024

(30) Foreign Application Priority Data
Feb. 17, 2022 (GB) 2202094.5

(51) Int. Cl. B01D 53/75; B01D 47/06; B01D 53/56; B01D 53/68; B01D 53/76; B01D 53/86; B03C 3/16

(52) U.S. Cl. CPC B01D 53/75; B01D 47/06; B01D 53/56; B01D 53/68; B01D 53/76; B01D 53/8628; B01D 53/864; B03C 3/16; B01D 2255/1021; B01D 2255/1023; B01D 2255/1025; B01D 2255/1026; B01D 2255/1028; B01D 2255/104; B01D 2255/2042; B01D 2255/2063; B01D 2255/2073; B01D 2255/20738; B01D 2255/20746; B01D 2255/20753; B01D 2255/20761; B01D 2255/20769; B01D 2255/20776; B01D 2255/20792; B01D 2255/2092; B01D 2255/504; B01D 2257/204; B01D 2257/402; B01D 2257/406; B01D 2257/553; B01D 2257/702; B01D 2258/0216

(57) ABSTRACT

An abatement apparatus includes: an abatement chamber configured to receive aneffluent stream and to provide an abated effluent stream; a wet scrubber located downstream of the abatement chamber, the wet scrubber being configured to receive the abated effluent stream and provide a scrubbed effluent stream; and a catalyst bed located downstream of the wet scrubber, the catalyst bed being configured to receive the scrubbed effluent stream and provide a remediated effluent stream. In this way, undesirable compounds present in the abated effluent stream, which are there because they were either already present in the effluent stream and were insufficiently abated by the abatement chamber or because they are abatement by-products generated within the abatement chamber, can be remediated, removed or reduced by the catalyst bed prior to being vented by the abatement apparatus.

### CROSS-REFERENCE OF RELATED APPLICATION

This application is a Section 371 National Stage Application of International Application No. PCT/GB2023/050358, filed Feb. 16, 2023, and published as WO 2023/156782 A1 on Aug. 24, 2023, the content of which is hereby incorporated by reference in its entirety and which claims priority of British Application No. 2202094.5, filed Feb. 17, 2022.

### FIELD

The field of the invention relates to an abatement apparatus and a method.

### BACKGROUND

Abatement apparatus for performing abatement are known and are typically used for treating an effluent gas stream from a manufacturing processing tool used in, for example, the semiconductor or flat panel display manufacturing industry. During such manufacturing, residual perfluorinated compounds (PFCs) and other compounds exist in the effluent gas stream pumped from the process tool. PFCs are difficult to remove from the effluent gas and their release into the environment is undesirable because they are known to have relatively high greenhouse activity.

Known abatement apparatus use combustion to remove the PFCs and other compounds from the effluent gas stream. Such other compounds may include but are not limited to silane (SiH₄), nitrous oxide (N₂O) or NF₃. Typically, the effluent gas stream is a nitrogen stream containing the aforementioned process gases. A fuel gas is often mixed with the effluent gas stream and that gas stream mixture is conveyed into a combustion chamber that is laterally surrounded by the exit surface of a foraminous gas burner. Fuel gas and air are simultaneously supplied to the foraminous burner to affect flameless combustion at the exit surface, with the amount of air passing through the foraminous burner seeking to be sufficient to consume not only the fuel gas supply to the burner, but also all the combustibles in the gas stream mixture injected into the combustion chamber. Electrically-heated and plasma abatement apparatus are also known and operate in a similar manner.

Although techniques exist for processing the effluent gas stream, they each have their own shortcomings. Accordingly, it is desired to provide an improved technique for processing an effluent gas stream.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect, there is provided an abatement apparatus for abating an effluent stream from a semiconductor processing tool, comprising: an abatement chamber configured to receive the effluent stream and to provide an abated effluent stream; a wet scrubber located downstream of the abatement chamber, the wet scrubber being configured to receive the abated effluent stream and provide a scrubbed effluent stream; and a catalyst bed located downstream of the wet scrubber, the catalyst bed being configured to receive the scrubbed effluent stream and provide a remediated effluent stream.

The first aspect recognizes that a problem with existing apparatus is that it can be difficult to achieve the required conditions within an abatement chamber to abate compounds within the effluent stream and/or any abatement by-products to levels that can be exhausted from the abatement apparatus. Also, the composition of PFCs and other compounds may not be maintained at a constant level in the effluent gas which can further add challenges with providing a successfully remediated effluent stream.

Accordingly, an abatement apparatus is provided. The abatement apparatus may be for abating an effluent stream. The effluent stream may be from a semi-conductor processing tool. The abatement apparatus may comprise an abatement chamber. The abatement chamber may be configured or arranged to receive the effluent stream. The abatement chamber may be configured or arranged to abate the effluent stream to provide an abated effluent stream. The abatement apparatus may comprise a wet scrubber. The wet scrubber may be located or positioned downstream of the abatement chamber. The wet scrubber may be configured or adapted to receive the abated effluent stream. The wet scrubber may scrub the abated effluent stream and provide a scrubbed effluent stream. The abatement apparatus may comprise a catalyst bed. The catalyst bed may be located or positioned downstream of the wet scrubber. The catalyst bed may be configured or arranged to receive the scrubbed effluent stream. The catalyst bed may support a catalytic reaction on the scrubbed effluent stream and provide a remediated effluent stream. The remediated effluent stream may have compounds which have been removed from the scrubbed effluent stream through the catalytic reaction with the catalyst bed. In this way, undesirable compounds present in the abated effluent stream, which are there because they were either already present in the effluent stream and were insufficiently abated by the abatement chamber or because they are abatement by-products generated within the abatement chamber or abatement reactants, can be remediated, removed or their concentration reduced by the catalyst bed prior to being vented by the abatement apparatus. This helps to improve the performance of the abatement apparatus by removing compounds which may otherwise be difficult or energy-intensive to remove using the abatement chamber alone.

The abatement chamber may be configured to provide the abated effluent stream containing at least one of at least one combustion by-product and at least one hydrocarbon and the catalyst bed may be configured to reduce a concentration of the at least one of at least one combustion by-product and at least one hydrocarbon present in the remediated effluent stream. Hence, combustion or abatement by-products and/or hydrocarbons may be remediated, removed or their concentration reduced using the catalyst bed.

The abatement chamber may be configured to provide the abated effluent stream with the at least one of at least one combustion by-product and at least one hydrocarbon at a concentration higher than a threshold amount and the catalyst bed may be configured to reduce a concentration of the at least one of at least one combustion by-product and at least one hydrocarbon present in the remediated effluent stream to less than the threshold amount. Accordingly, the catalyst bed may reduce the concentration of the combustion by-product or hydrocarbon to typically less than an environmentally-acceptable threshold amount.

The abatement chamber may be configured to provide the abated effluent stream with the at least one of at least one combustion by-product and at least one hydrocarbon at a concentration higher than a threshold amount at a temperature lower than providing the abated effluent stream with the at least one of at least one combustion by-product and at least one hydrocarbon at a concentration lower than the threshold amount. Accordingly, the abatement chamber may be operated at a temperature which is lower than that which it would otherwise need to operate at in order to provide the combustion by-product and/or the hydrocarbon at the concentration which is lower than the threshold amount. In other words, it is possible to operate the abatement chamber at a lower temperature, which results in an increased concentration of the combustion by-product or the hydrocarbon, but that combustion by-product or hydrocarbon may then be remediated by the catalyst bed. This helps to reduce the overall energy consumption of the abatement apparatus.

The abatement chamber may be configured to provide the abated effluent stream with at least one of a plurality of combustion by-products and a plurality of hydrocarbons each at an initial concentration and the catalyst bed may be configured to perform a plurality of catalytic reactions on the scrubbed effluent stream and provide the remediated effluent stream with the at least one of the plurality of combustion by-products and the plurality of hydrocarbons each at lower than the initial concentration. Accordingly, a number of different catalysts may be provided, each of which may perform a catalytic reaction on one or more associated combustion by-products and/or hydrocarbons in order to lower their concentrations.

The catalyst bed may comprise at least one catalytic material for at least one of: direct decomposition of N₂O; reduction and/or decomposition of NO_{X}; and oxidation of at least one of CO and a hydrocarbon.

The catalyst bed may comprise a catalytic material comprising at least one of a metal oxide material, a metal oxide and precious metal on a support.

The support may comprise at least one of titanium, aluminium, zirconium and silicon-based oxides. Such examples include silica, silicalites, alumino-silicates titanium dioxide, zirconia, alumina and zeolites.

The precious metal may comprise at least one platinum group metal.

The platinum group metal may comprise at least one of platinum, palladium, rhodium, iridium, ruthenium and osmium.

Whilst the abatement chamber may be configured to produce reaction by-products such as CO as mentioned above these can be remediated using a catalyst for CO. Such catalyst examples include for example at least one of: hopcalite (copper manganese spinel), lanthanum cuprate and precious metals on supports as mentioned above.

The catalytic material for at least one of direct decomposition of N₂O and oxidation of CO may comprise at least one of: a hopcalite (copper manganese spinel); lanthanum cuprate; iron, cobalt, nickel, manganese, palladium, platinum, indium and/or silver impregnated to traditional supports such as alumina, silica, titania and/or zeolite supports such as ZSM5, BEA, ferrierite and/or mordenite; composite copper, zinc and/or aluminium catalysts also containing alkali and/or alkaline earth metals may also be used.

The catalytic material for the direct reduction or decomposition of NOₓ may include at least one of: Cu-ZSM5, a precious metal catalyst on a support material such as alumina and/or silica, and/or a metal organic framework type catalyst.

The catalytic material for oxidation of at least one of CO and a hydrocarbon comprises at least one of: silver, platinum, palladium, rhodium, iridium, ruthenium and/or osmium on suitable zeolitic supports and/or other supports comprising at least one of silicon, zirconium, aluminium and/or titanium based oxides; zeolite type supports such as ZSM5, BEA, ferrierite and/or mordenite where metals such as cobalt, nickel, manganese, palladium, indium and/or silver may be impregnated to such zeolite supports; and materials doped with molybdenum, niobium, and/or tungsten based oxides and further doped with alkali, alkaline earth materials and/or barium.

It may also be favourable to operate the abatement chamber in a manner described above so as to increase the concentration of reaction by-products such as CO or hydrocarbons. These can then react on a catalyst bed to produce CO₂ and/or may further react on a catalyst bed with NOₓ to produce nitrogen. It is recognised that shortcomings of such catalytic technologies are related to their ability to also be operable in the presence of water vapour resulting from the scrubbed effluent and varying concentrations of combustion by-products, such as CO₂, O₂ and also other compounds in the scrubbed effluent stream which may also be present in the original effluent stream. Appropriate catalyst examples for CO, hydrocarbons and/or NOₓ include at least one of: silver, platinum, palladium, rhodium, iridium, ruthenium and/or osmium on suitable zeolitic supports or other supports comprising at least one of silicon, zirconium, aluminium or titanium based oxides. Catalysts comprising zeolite type supports such as ZSM5, BEA, ferrierite or mordenite may be alternatively used where metals such as cobalt, nickel, iron, manganese, palladium, indium or silver may be impregnated to such zeolite supports. The catalytic materials may also be doped with molybdenum, niobium, or tungsten based oxides and further doped with alkali or alkaline Earth metals.

The catalyst bed may comprise a plurality of catalytic materials.

The catalytic material for oxidation of at least one of CO and a hydrocarbon (to reduce their concentrations) may be located one of upstream and downstream of the catalytic material for direct decomposition of N₂O. The catalytic material for reducing the concentrations of CO and/or hydrocarbon may typically need to operate at a lower temperature than the catalytic material for the decomposition of N₂O. By locating one downstream of the other, this helps to ensure that any exothermic reaction caused by an upstream catalytic material helps to heat any downstream catalytic material. In some embodiments, the hydrocarbon/CO catalyst would precede the N₂O catalyst, since otherwise the N₂O catalyst may consume the CO or hydrocarbon necessary to facilitate NOₓ reduction or decomposition. Additionally, the hydrocarbon/CO catalyst may produce N₂O in the presence of NOₓ, which would then be removed with the downstream N₂O catalyst. This also reduces the opportunity for the N₂O catalyst to be poisoned with NOₓ which, is removed using the preceding catalyst by reaction with the hydrocarbon and/or CO. In other embodiments it may be favourable to position an N₂O catalyst upstream of a hydrocarbon catalyst, such that the N₂O does not consume the combustion by-products and/or hydrocarbons which would otherwise provide further remediation for NOₓ on a downstream catalyst bed.

The abatement chamber may be configured to increase a concentration of at least one of at least one combustion by-product and at least one hydrocarbon to cause an increase in an exothermic catalytic reaction to increase an operating temperature of the catalyst bed. Accordingly, the temperature of the catalytic reactions can be controlled simply by changing the abatement conditions within the abatement chamber, which avoids the need for separate heating devices to heat the catalyst bed.

The abatement chamber may be configured to increase a concentration of at least one of CO and a hydrocarbon to cause the increase in the exothermic catalytic reaction to increase an operating temperature of the catalyst bed.

The abatement chamber may be configured to temporarily increase the concentration of the at least one of the at least one combustion by-product and the at least one hydrocarbon to cause the increase in the exothermic catalytic reaction to increase the operating temperature of the catalyst bed.

The abatement chamber may be configured to sequence an increase a concentration of at least one of a plurality of combustion by-products and a plurality of hydrocarbons to cause an increase in rates of a sequence of exothermic catalytic reactions.

The abatement chamber may be configured to sequence an increase in a concentration of one of more of CO, then hydrocarbon, then N₂O to cause the increase in rates of the sequence of exothermic catalytic reactions.

The catalyst bed may comprise a heat exchanger configured to pre-heat the effluent stream prior to being provided to the abatement chamber. Pre-heating the effluent stream helps to recirculate heat and reduce the overall energy consumption of the abatement apparatus.

According to a second aspect, there is provided a method of abating an effluent stream from a semiconductor processing tool, comprising: receiving the effluent stream, abating the effluent stream with an abatement chamber and providing an abated effluent stream; receiving the abated effluent stream, scrubbing the abated effluent stream with a wet scrubber being and providing a scrubbed effluent stream; and receiving the scrubbed effluent stream, remediating the scrubbed effluent stream with a catalyst bed located downstream of said wet scrubber and providing a remediated effluent stream.

The method may comprise controlling the abatement chamber to provide the abated effluent stream containing at least one of at least one combustion by-product and at least one hydrocarbon and configuring the catalyst bed to reduce a concentration of the at least one of at least one combustion by-product and at least one hydrocarbon present in the remediated effluent stream.

The method may comprise controlling the abatement chamber to provide the abated effluent stream with the at least one of at least one combustion by-product and at least one hydrocarbon at a concentration higher than a threshold amount and configuring the catalyst bed to reduce a concentration of the at least one of at least one combustion by-product and at least one hydrocarbon present in the remediated effluent stream to less than the threshold amount.

The method may comprise controlling the abatement chamber to provide the abated effluent stream with the at least one of at least one combustion by-product and at least one hydrocarbon at a concentration higher than a threshold amount at a temperature lower than providing the abated effluent stream with the at least one of at least one combustion by-product and at least one hydrocarbon at a concentration lower than the threshold amount.

The method may comprise controlling the abatement chamber to provide the abated effluent stream with at least one of a plurality of combustion by-products and a plurality of hydrocarbons each at an initial concentration and configuring the catalyst bed to perform a plurality of catalytic reactions on the scrubbed effluent stream and provide the remediated effluent stream with the at least one of the plurality of combustion by-products and the plurality of hydrocarbons each at lower than the initial concentration.

The catalyst bed may comprise at least one catalytic material for at least one of: direct decomposition of N₂O; reduction or decomposition of NO_{X}; and oxidation of at least one of CO and a hydrocarbon.

The catalyst bed may comprise a catalytic material comprising at least one of a metal oxide material, a metal oxide and precious metal on a support.

The support may comprise at least one of titanium, aluminium, zirconium and silicon-based oxides. Such examples include silica, silicalites, alumino-silicates titanium dioxide, zirconia, alumina and zeolites.

The precious metal may comprise at least one platinum group metal.

The platinum group metal may comprise at least one of platinum, palladium, rhodium, iridium, ruthenium and osmium.

Whilst the abatement chamber may be configured to produce reaction by-products such as CO as mentioned above these can be remediated using a catalyst for CO. Such catalyst examples include for example at least one of: hopcalite (copper manganese spinel), lanthanum cuprate or and precious metals on supports as mentioned above.

The catalytic material for at least one of direct decomposition of N₂O and oxidation of CO may comprise at least one of: a hopcalite (copper manganese spinel); lanthanum cuprate; iron, cobalt, nickel, manganese, palladium, platinum, indium or silver impregnated to traditional supports such as alumina, silica, or titania or zeolite supports such as ZSM5, BEA, ferrierite or mordenite; composite copper, zinc, aluminium catalysts also containing alkali or alkaline earth metals may also be used.

The catalytic material for the direct reduction or decomposition of NOₓ may include at least one of: Cu-ZSM5, a precious metal catalyst on a support material such as alumina or silica, or a metal organic framework type catalyst.

The catalytic material for oxidation of at least one of CO and a hydrocarbon comprises at least one of: silver, platinum, palladium, rhodium, iridium, ruthenium and/or osmium on suitable zeolitic supports and/or other supports comprising at least one of silicon, zirconium, aluminium and/or titanium based oxides; zeolite type supports such as ZSM5, BEA, ferrierite and/or mordenite where metals such as cobalt, nickel, manganese, palladium, indium and/or silver may be impregnated to such zeolite supports; and materials doped with molybdenum, niobium, and/or tungsten based oxides and further doped with alkali, alkaline earth materials and/or barium.

It may also be favourable to operate the abatement chamber in a manner described above so as to increase the concentration of reaction by-products such as CO or hydrocarbons. These can then react on a catalyst bed to produce CO₂ and/or may further react on a catalyst bed with NOₓ to produce nitrogen. It is recognised that shortcomings of such catalytic technologies are related to their ability to also be operable in the presence of water vapour resulting from the scrubbed effluent and varying concentrations of combustion by-products, such as CO₂, O₂ and also other compounds in the scrubbed effluent stream which may also be present in the original effluent stream. Appropriate catalyst examples for CO, hydrocarbons and/or NOₓ include at least one of: silver, platinum, palladium, rhodium, iridium, ruthenium and/or osmium on suitable zeolitic supports or other supports comprising at least one of silicon, zirconium, aluminium or titanium based oxides. Catalysts comprising zeolite type supports such as ZSM5, BEA, Ferrierite and/or Mordenite may be alternatively used where metals such as Cobalt, Nickel, Iron, Manganese, Palladium, Indium and/or Silver may be impregnated to such zeolite supports. The catalytic materials may also be doped with Molybdenum, Niobium, and/or Tungsten based oxides and further doped with alkali and/or alkaline earth metals.

The catalyst bed may comprise a plurality of catalytic materials.

The method may comprise configuring the catalyst bed so that the catalytic material for reduction of at least one of CO and a hydrocarbon is located one of upstream and downstream of the catalytic material for direct decomposition of N₂O.

The catalytic material for oxidation or decomposition of CO and/or hydrocarbon may typically need to operate at a lower temperature than the catalytic material for the decomposition of N₂O. By locating one downstream of the other, this helps to ensure that any exothermic reaction caused by an upstream catalytic material helps to heat any downstream catalytic material. In some embodiments, the hydrocarbon/CO catalyst would precede the N₂O catalyst, since otherwise the N₂O catalyst may consume the CO or hydrocarbon necessary to facilitate NOx reduction or decomposition. Additionally, the hydrocarbon/CO catalyst may produce N₂O in the presence of NOₓ, which would then be removed with the downstream N₂O catalyst. This also reduces the opportunity for the N₂O catalyst to be poisoned with NOₓ which, is removed using the preceding catalyst by reaction with the hydrocarbon and/or CO. In other embodiments it may be favourable to position an N₂O catalyst upstream of a hydrocarbon catalyst, such that the N₂O does not consume the combustion by-products and/or hydrocarbons which would otherwise provide further remediation for NOₓ on a downstream catalyst bed.

The method may comprise controlling the abatement chamber to increase a concentration of at least one of at least one combustion by-product and at least one hydrocarbon to cause an increase in an exothermic catalytic reaction to increase an operating temperature of the catalyst bed.

The method may comprise controlling the abatement chamber to increase a concentration of at least one of CO and a hydrocarbon to cause the increase in the exothermic catalytic reaction to increase an operating temperature of the catalyst bed.

The method may comprise controlling the abatement chamber to temporarily increase the concentration of the at least one of the at least one combustion by-product and the at least one hydrocarbon to cause the increase in the exothermic catalytic reaction to increase the operating temperature of the catalyst bed.

The method may comprise controlling the abatement chamber to sequence an increase a concentration of at least one of a plurality of combustion by-products and a plurality of hydrocarbons to cause an increase in rates of a sequence of exothermic catalytic reactions.

The method may comprise controlling the abatement chamber to sequence an increase in a concentration of one of more of CO, then a hydrocarbon, then N₂O, to cause the increase in rates of the sequence of exothermic catalytic reactions.

The method may comprise providing the catalyst bed with a heat exchanger and pre-heating the effluent stream prior to being provided to the abatement chamber with the heat exchanger.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 illustrates schematically an abatement apparatus according to one embodiment; and

FIGS. 2A to 2G illustrate schematically different configurations of the catalyst bed.

### DETAILED DESCRIPTION

Before discussing the embodiments in any more detail, first an overview will be provided. Some embodiments provide an arrangement for abating compounds in an effluent stream from, for example, a semiconductor processing tool. An abatement chamber receives the effluent stream to be abated, performs the abatement and provides the abated effluent stream to a scrubber arrangement which scrubs the abated effluent stream and provides a scrubbed effluent stream. The scrubbed effluent stream is provided to a catalyst bed. The scrubbed effluent stream undergoes a catalytic reaction with catalysts in the catalyst bed and provides a remediated effluent stream. This enables the abatement apparatus to abate, remove, reduce the concentration of, break down or remediate compounds present within the effluent stream prior to being exhausted, typically to atmosphere. The arrangement of the abatement chamber in combination with the catalyst bed enables compounds that would otherwise be problematic or energy-intensive to be abated by the abatement chamber, to instead be remediated, broken down or reacted to a more suitable compound using the catalyst bed. This enables the abatement chamber to be operated at lower temperatures which reduces the stress on the abatement chamber, as well as reducing the energy consumption of the abatement apparatus and providing for improved abatement of some compounds. In some embodiments, combinations of catalytic materials can be provided within the catalyst bed in order to support the remediation of different compounds or classes of compounds within the effluent stream. Also, since the reactivity of some catalysts can be temperature-dependent, the operation of the abatement chamber can be controlled using a controller to cause some catalysts within the catalyst bed to perform exothermic reactions in order to increase heat near the catalysts and achieve the required reactivity, which avoids the need to provide an electrical heater to provide that heat. Furthermore, in some embodiments, the catalyst bed acts as a heat exchanger in order to help pre-heat the incoming effluent stream.

In some embodiments, different catalysts and different combinations of catalysts are provided to support different types of reactions to remediate compounds flowing over the catalyst bed. It is recognised that shortcomings of particular catalytic technologies are related to their ability to also be operable in the presence of water vapour resulting from the scrubbed effluent and varying concentrations of combustion by-products, such as CO₂, O₂ and also other compounds such in the scrubbed effluent stream which may also be present in the original effluent stream.

In some embodiments, a catalyst is provided for remediating CO only. However, it will be appreciated that a catalyst provided for remediating both NOₓ+CO catalyst, as well as a catalyst provided for remediating N₂O catalyst may also be utilised for CO in the absence of NOₓ or N₂O. Catalysts for remediating CO only include one or more of the following hopcalite (copper manganese spinel) and/or lanthanum cuprate (lathanum copper spinel) may be used. Catalysts comprising any of precious metals such as platinum, palladium, rhodium, iridium, ruthenium and/or osmium on suitable zeolitic supports and/or other supports comprising at least one of silicon, zirconium, aluminium or titanium may be used. Gold on supports such as ceria-oxides may also be used for this purpose.

In some embodiments, a catalyst is provided for remediating NO (i.e. removing NO without any additional reductant). Such catalysts include one or more of the following. A catalyst such as Cu-ZSM5 or a precious metal catalyst on a support material such as alumina and/or silica or metal organic framework type catalyst exhibiting NO reduction activity.

In some embodiments, a catalyst is provided for remediating for NO+CO (i.e. removing NO using CO as the reductant)—it will be appreciated that this may generate some N₂O and hence require the N₂O catalyst after it. Catalysts for remediating for NO+CO, in particular in the presence of water and oxygen include one or more of the following. Catalysts comprising any of precious metals such as platinum, palladium, rhodium, iridium, ruthenium and/or osmium on suitable supports. Suitable supports include various zeolites such as ZSM5 and BEA zeolite, and/or those comprising on of silicon, zirconium, aluminium and/or titanium based oxides. The catalytic materials may also be doped with molybdenum, niobium, barium and/or tungsten based oxides and/or further doped with alkali and/or alkaline earth materials.

In some embodiments, a catalyst is provided for remediating N₂O. Such catalysts include one or more of the following. Catalysts comprising zeolite supports such as ZSM5, BEA, Ferrierite, Mordenite and/or traditional supports such as alumina, titania and/or silica. Metals such as iron, cobalt, nickel, manganese, palladium, indium and/or silver may be impregnated to such supports. Hopcalites (copper manganese spinels) may be utilised for this purpose and/or composite copper, zinc, aluminium catalysts also containing alkali and/or alkaline earth metals.

In some embodiments, a catalyst is provided for remediating NO+hydrocarbon (or only for remediating hydrocarbon only if utilising this to adjust reactor temperature). Such catalysts include one or more of the following. Catalysts comprising zeolite supports such as ZSM5, BEA, ferrierite and/or mordenite. Metals such as cobalt, nickel, manganese, palladium, indium and/or silver may be impregnated to such zeolite supports or additionally to other aluminium, zirconium, silicon and titanium oxide based supports. Precious metals such as palladium on a suitable support such as sulphated zirconia, or titania may be utilised for this purpose.

### Abatement Apparatus

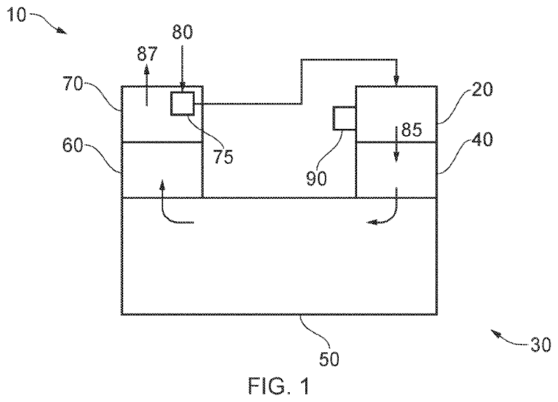

FIG. 1 illustrates schematically an abatement apparatus 10 according to one embodiment. The abatement apparatus 10 has an abatement chamber 20 coupled with a downstream scrubber 30. In this embodiment, the scrubber 30 comprises a weir and spray nozzle structure 40, a downstream sump 50 and a downstream combined packed tower and wet electrostatic precipitator 60. Downstream of the combined packed tower and wet electrostatic precipitator 60 is a catalyst bed 70.

In general, an effluent stream 80 (together with any combustion reagents required) enters the abatement chamber 20 where compounds within the effluent stream 80 are abated to produce an abated effluent stream 85. The abated effluent stream 85 flows into the downstream weir and spray nozzle structure 40, where it is cooled by a weir and large particulates are removed by a spray produced by a spray nozzle and then flows into the sump 50. The abated effluent stream 85 then flows up through the combined packed tower and wet electrostatic precipitator 60 which further traps particulates in the abated effluent stream 85 and helps to remove soluble compounds from within the abated effluent stream 85. The abated effluent stream 85 then continues and flows over the downstream catalyst bed 70 where one or more catalytic reactions occur between compounds within the abated effluent stream 85, in order to remediate, break down or remove those compounds from the abated effluent stream prior to venting a remediated effluent stream 87, typically to atmosphere.

As will be explained in more detail below, a controller 90 may control conditions within the abatement chamber 20 in order to vary the concentration of compounds exiting the abatement chamber within the abated effluent stream 85 in order to cause one or more exothermic reactions to occur with the catalyst bed 70 in order to adjust the reactivity of one or more catalysts within the catalyst bed 70. This approach avoids the need to provide the catalyst bed 70 with a heating element to control the reactivity of the catalyst bed 70.

Also, as shown in FIG. 1, the catalyst bed 70 can be provided as part of a heat exchanger 75 in order to help pre-heat the effluent stream 80 prior to being introduced into the abatement chamber 20. This provides for a degree of heat recovery which helps to reduce the energy consumption of the abatement apparatus 10.

The effluent stream can contain a number of different compounds for abatement depending on the operation of the upstream semiconductor processing tool. For example, the effluent stream can contain N₂O, SiH₄, NH₃ and NF₃ at various times and in various concentrations or amounts. Depending on the conditions within the abatement chamber, various different compounds may exit the abatement chamber 20 in the abated effluent stream 85. For example, the N₂O can result in NO_{X}, some residual N₂O, as well as N₂ within the abated effluent stream. Likewise, SiH₄ can lead to SiO₂ in the abated effluent stream. NH₃ can lead to NO_{X}, CH₄, CO₂ and CO in the abated effluent stream. NF₃ can lead to NO_{X} and HF in the abated effluent stream. The presence of N₂O, NO, NO₂ and/or CO in the abated effluent stream is undesirable and typically environmental and/or safety rules require that the gas flow vented from the abatement apparatus 10 has concentration or part per million levels of these compounds below specified threshold amounts. However, optimizing the abatement chamber 20 to achieve those threshold amounts is difficult and typically requires very high energy consumption. However, the catalyst bed 70 contains one or more catalysts which are optimized to support a catalytic reaction which remediates, abates or decomposes these compounds into safer compounds such as carbon dioxide, nitrogen and oxygen.

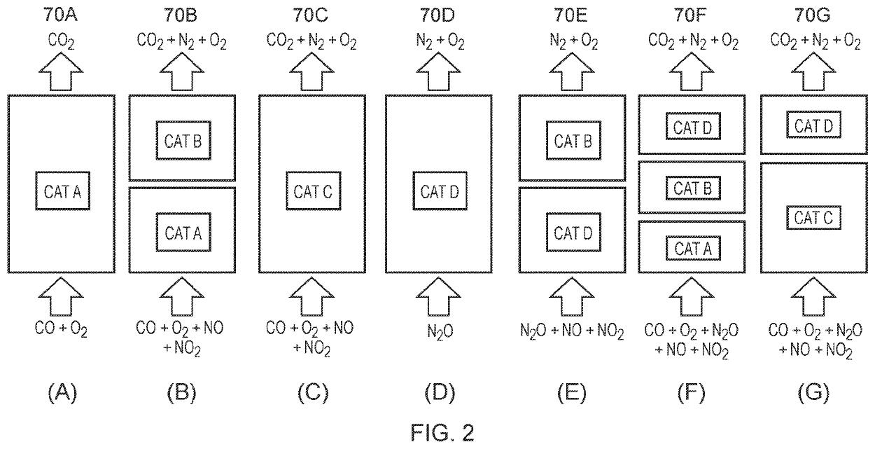

FIGS. 2A-G illustrate schematically the configuration of different catalyst beds 70A-G according to embodiments. The catalyst beds 70A-G are provided in a suitable physical configuration to ensure that sufficient surface area is provided to support the required reactions. That configuration can also be provided as part of the heat exchanger 75.

FIG. 2A shows an arrangement where excess CO and O₂ in the abated effluent stream 85 are to be remediated. In this example, the catalyst bed 70A comprises catalyst A. Catalyst A causes CO₂ to be produced from the CO and O₂.

FIG. 2B shows an arrangement where excess CO, O₂, NO and NO₂ in the abated effluent stream 85 are to be remediated. In this example, the catalyst bed 70B comprises catalyst A together with catalyst B. Catalyst A operates as mentioned above, while catalyst B causes N₂ and O₂ to be produced from the NO and NO₂.

FIG. 2C shows an arrangement where excess CO and/or hydrocarbon, O₂, NO and NO₂ in the abated effluent stream 85 are to be remediated. In this example, the catalyst bed 70C comprises a single catalyst C. Catalyst C caused CO₂ to be produced from the CO and/or hydrocarbon and O₂ as well as causing N₂ and O₂ to be produced from the NO and NO₂. This catalyst may also be used to remediate hydrocarbon only, or CO only, where this is being used to provide heat to increase catalyst temperature.

FIG. 2D shows an arrangement where excess N₂O in the abated effluent stream 85 is to be remediated. In this example, the catalyst bed 70D comprises catalyst D. Catalyst D causes N₂ and O₂ to be produced from the N₂O.

FIG. 2E shows an arrangement where excess N₂O, NO and NO₂ in the abated effluent stream 85 are to be remediated. In this example, the catalyst bed 70E comprises catalyst D together with catalyst B which each operate as mentioned above.

FIG. 2F shows an arrangement where excess CO, O₂, N₂O, NO and NO₂ in the abated effluent stream 85 are to be remediated. In this example, the catalyst bed 70F comprises catalyst A, together with catalysts B and D which each operate as mentioned above.

FIG. 2G shows an arrangement where excess CO, O₂, N₂O, NO and NO₂ in the abated effluent stream 85 are to be remediated. In this example, the catalyst bed 70G comprises catalyst D, together with catalyst C which each operate as mentioned above. In this arrangement, catalyst C may precede catalyst D, since otherwise catalyst D may consume CO or catalyst D may become NO poisoned. Additionally, catalyst C may make N₂O, which we would then be removed with catalyst D. Alternatively, catalyst D may precede catalyst C in order that N₂O does not cause competitive reaction with the hydrocarbon/CO reaction occurring on catalyst C. In this instance catalyst D also supplies heat to assist in the reaction on catalyst C.

Some examples of catalyst A for the oxidation of CO include one of more of the following: hopcalite (copper manganese spinel) or lanthanum cuprate may be used for CO oxidation in the presence of oxygen. Catalysts comprising any of precious metals such as silver, platinum, palladium, rhodium, iridium, ruthenium and/or osmium on suitable zeolitic supports or other supports comprising at least one of silicon, aluminium and/or titanium may be used. Catalysts such as gold on cerium oxides may also be used for this purpose.

Some examples of catalyst B for the decomposition or reduction of NO_{X} include one or more of the following. A catalyst such as Cu-ZSM5, and/or a precious metal catalyst on a support material such as alumina and/or silica and/or metal organic framework type catalyst exhibiting NO reduction activity.

Some examples of catalyst C for reacting NO together with CO and/or a hydrocarbon to include one or more of the following. silver, platinum, palladium, rhodium, iridium, ruthenium and/or osmium on suitable zeolitic supports and/or other supports comprising at least one of silicon, zirconium, aluminium and titanium based oxides. Catalysts comprising zeolite type supports such as ZSM5, BEA, ferrierite and/or mordenite may be alternatively used where metals such as cobalt, nickel, manganese, palladium, indium and/or silver may be impregnated to such zeolite supports. The catalytic materials may also be doped with molybdenum, niobium, and/or tungsten based oxides and/or further doped with alkali, alkaline earth materials and/or barium.

Some examples of catalyst D for the direct decomposition of N₂O include one or more of the following. A hopcalite (copper manganese spinel); lanthanum cuprate; iron, cobalt, nickel, manganese, palladium, platinum, indium and/or silver impregnated to traditional supports such as alumina, silica, and/or titania or zeolite supports such as ZSM5, BEA, ferrierite and/or mordenite; composite copper, zinc, aluminium catalysts also containing alkali and/or alkaline earth metals may also be used. In some embodiments, the NO+CO catalyst would precede the N₂O catalyst, since otherwise the N₂O catalyst may consume CO or the N₂O catalyst may become NO poisoned.

Hence, it can be seen that some embodiments provide an apparatus and method of operation of the apparatus for abating N₂O, NO, NO₂ and CO comprising a burner-washer and a catalyst. As mentioned above, some semiconductor processes use N₂O which is a potent greenhouse gas. Combustive abatement of N₂O can result in partial conversion to NO and, to a lesser extent NO₂, both of which are harmful to human health and to the environment. Combustive destruction of other N-containing gases, such as NH₃ or NF₃, can also lead to the production of NOₓ. The formation of NOₓ can be limited by tuning the conditions in the combustor (ratio of fuel to oxidant), but this typically results in increased formation of CO.

Some embodiments provide a burner washer with downstream catalyst bed for either N₂O, NO, NO₂ and/or CO abatement. Ideally, the burner conditions are optimised for the abatement of hazardous substances other than N₂O which, ideally, should pass through the burner unabated. A downstream wet scrubber may seem counter intuitive, this helps to remove acid gases and particulate matter to protect the catalyst. The wet scrubber may additionally comprise a wet electrostatic precipitator. The catalyst may be one or more of a variety of materials with demonstrable N₂O, NO, NO₂ or CO destruction performance. A surprising though useful choice would be hopcalite—a blend of manganese oxide and copper oxide. A variety of grades are available, differing in their detailed composition, being optimised for one or more niche applications. An advantage of using hopcalite is that it oxidises CO at room temperature and hydrocarbons at moderately elevated temperature. N₂O abatement requires temperatures in excess of 400° C. Thus, by deliberately operating the burner under rich conditions (that lead to the production of CO) the catalyst can be heated. ‘By tuning the abatement to also emit CO it results in a lower NO_{X} output, where the hopcalite catalyst then serves to reduce the CO in the final effluent which, also serves to remove the increased concentrations of N₂O resulting from the altered burner conditions Further synergies are also apparent where heating can be achieved by allowing fuel gas (e.g. methane) to pass over the catalyst. If a heat exchanger is included, the off gases from the catalyst can be used to preheat the effluent stream. The destruction of N₂O over the catalyst is exothermic, thus the heat produced can offset losses from the system. Should the temperature fall below a preset value, either the burner can be adjusted to increase CO and/or hydrocarbon emissions or a valve might be opened to allow a controlled flow of fuel over the catalyst. The catalytic reactor may also comprise an electric heater. For certain combinations of gases in the effluent stream, it may be that the effluent from the abatement chamber contains NO_{X} which is at a level higher than the environmental threshold value. In these cases it may be desirable to use assistance from hydrocarbon catalysts to remove NO_{X}. Additionally, it is understood that burner conditions may result in varying levels of oxygen in the exhaust which, can consume hydrocarbon and/or CO preferentially over reaction with NO_{X}. For example, with other catalysts such as Iridium on such supports as silica, optionally doped with metals such as tungsten and barium, it may be advantageous to allow CO to flow over the catalyst during the abatement of NO and NO₂, in either the absence of presence of oxygen and/or water, so as to serve as a reductant. In other embodiments, it may be preferential to utilise a ferrierite, for example a cobalt ferrierite optionally doped with, for example, a platinum group metal, and/or indium, which may oxidise methane to enable NO_{X} removal and reactor heating whilst also enabling N₂O removal. The catalyst bed may comprise up to three separate catalysts, one optimised for the direct decomposition of N₂O, the other for reduction of NO and NO₂ and the third for the oxidation of CO and hydrocarbons. The particular set of catalysts are chosen as such since they may be arranged with particular synergies as identified. For example, historically, issues associated with platinum group metal catalysts such as the aforementioned iridium or platinum catalysts are the result of by-product N₂O production, however by utilizing these platinum group metal catalysts which are poor at methane conversion and having the iridium catalyst preceding the cobalt ferrierite catalyst, then both N₂O and NO removal can be achieved successfully.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. An abatement apparatus for abating an effluent stream from a semiconductor processing tool, comprising:
an abatement chamber configured to receive said effluent stream and to provide an abated effluent stream;
a wet scrubber located downstream of said abatement chamber, said wet scrubber being configured to receive said abated effluent stream and provide a scrubbed effluent stream; and
a catalyst bed located downstream of said wet scrubber, said catalyst bed being configured to receive said scrubbed effluent stream and provide a remediated effluent stream.

2. The abatement apparatus of claim 1, wherein said abatement chamber is configured to at least one of:
provide said abated effluent stream containing at least one of at least one combustion by-product and at least one hydrocarbon and said catalyst bed is configured to reduce a concentration of said at least one of at least one combustion by-product and at least one hydrocarbon present in said remediated effluent stream;
provide said abated effluent stream with said at least one of at least one combustion by-product and at least one hydrocarbon at a concentration higher than a threshold amount and said catalyst bed is configured to reduce a concentration of said at least one of at least one combustion by-product and at least one hydrocarbon present in said remediated effluent stream to less than said threshold amount; and
provide said abated effluent stream with at least one of a plurality of combustion by-products and a plurality of hydrocarbons each at an initial concentration and said catalyst bed is configured to perform a plurality of catalytic reactions on said scrubbed effluent stream and provide said remediated effluent stream with said at least one of said plurality of combustion by-products and said plurality of hydrocarbons each at lower than said initial concentration.

3. The abatement apparatus of claim 1, wherein catalyst bed comprises a catalytic material comprising at least one of a metal oxide material, a metal oxide and precious metal on a support and preferably wherein said support comprises at least one of titania, alumina, zirconium, silicon-based oxides.

4. The abatement apparatus of claim 1, wherein said catalyst bed comprises at least one catalytic material for at least one of:
direct decomposition of N2O
at least one of direct reduction and decomposition of NOX; and
oxidation of at least one of CO and a hydrocarbon.

5. The abatement apparatus of claim 4, wherein said catalytic material for direct decomposition of N2O and oxidation of CO comprises at least one of:
a hopcalite (copper manganese spinel);
lanthanum cuprate;
iron, cobalt, nickel, manganese, palladium, platinum, indium and/or silver impregnated to traditional supports such as alumina, silica, and/or titania and/or zeolite supports such as ZSM5, BEA, ferrierite and/or mordenite; and
composite copper, zinc and/or aluminium catalysts also containing alkali and/or alkaline earth metals.

6. The abatement apparatus of claim 4, wherein said catalytic material for reduction or decomposition of NOX comprises at least one of:
Cu-ZSM5; and
a precious metal catalyst on a support material such as alumina and/or silica, and/or a metal organic framework type catalyst.

7. The abatement apparatus of claim 4, wherein said catalytic material for oxidation of at least one of CO and a hydrocarbon comprises at least one of:
silver, platinum, palladium, rhodium, iridium and/or ruthenium on suitable zeolitic supports and/or other supports comprising at least one of silicon, zirconium, aluminium and/or titanium based oxides;
zeolite type supports such as ZSM5, BEA, ferrierite and/or mordenite where metals such as cobalt, nickel, manganese, palladium, indium or silver may be impregnated to such zeolite supports; and
materials doped with molybdenum, niobium, and/or tungsten based oxides and further doped with alkali, alkaline earth materials and/or barium.

8. The abatement apparatus of claim 1, wherein said catalyst bed comprises a plurality of catalytic materials.

9. The abatement apparatus of claim 4, wherein said catalytic material for oxidation of at least one of CO and hydrocarbon is located one of upstream and downstream of said catalytic material for direct decomposition of N2O.

10. The abatement apparatus of claim 1, wherein said abatement chamber is configured to at least one of:
increase a concentration of at least one of at least one combustion by-product and at least one hydrocarbon to cause an increase in an exothermic catalytic reaction to increase an operating temperature of said catalyst bed; and
increase a concentration of at least one of CO and/or hydrocarbon to cause said increase in said exothermic catalytic reaction to increase an operating temperature of said catalyst bed.

11. The abatement apparatus of claim 1, wherein said abatement chamber is configured to temporarily increase said concentration of said at least one of said at least one combustion by-product and said at least one hydrocarbon to cause said increase in said exothermic catalytic reaction to increase said operating temperature of said catalyst bed.

12. The abatement apparatus of claim 1, wherein said abatement chamber is configured to sequence an increase a concentration of at least one of a plurality of combustion by-products and a plurality of hydrocarbons to cause an increase in rates of a sequence of exothermic catalytic reactions.

13. The abatement apparatus of claim 12, wherein said abatement chamber is configured to sequence an increase a concentration of one of more of CO, then hydrocarbon, then N2O to cause said increase in rates of said sequence of exothermic catalytic reactions.

14. The abatement apparatus of claim 1, wherein said catalyst bed comprises a heat exchanger configured to pre-heat said effluent stream prior to being provided to said abatement chamber.

15. A method of abating an effluent stream from a semiconductor processing tool, comprising:
receiving said effluent stream, abating said effluent stream with an abatement chamber and providing an abated effluent stream;
receiving said abated effluent stream, scrubbing said abated effluent stream with a wet scrubber being and providing a scrubbed effluent stream; and
receiving said scrubbed effluent stream, remediating said scrubbed effluent stream with a catalyst bed located downstream of said wet scrubber and providing a remediated effluent stream.
